(19) United States
(12) Patent Application Publication
(10) Pub. No.: US 2025/0293276 A1
(43) Pub. Date: Sep. 18, 2025

(54) ELECTRIC POWER SUPPLY SYSTEM

(71) Applicant: HONDA MOTOR CO., LTD., TOKYO (JP)

(72) Inventors: Yukihiro FUKUSHIMA, WAKO-SHI (JP); Tai TOMIZAWA, WAKO-SHI (JP); Ryota KITAMOTO, WAKO-SHI (JP)

(21) Appl. No.: 19/046,729

(22) Filed: Feb. 6, 2025

(30) Foreign Application Priority Data
Mar. 18, 2024 (JP) 2024-042000

(51) Int. Cl. H01M 8/04302; H01M 8/0432; H01M 8/04537; H01M 16/00

(52) U.S. Cl. CPC H01M 8/04302; H01M 8/04373; H01M 8/04626; H01M 16/006

(57) ABSTRACT

A control device calculates a required startup power as an electric power required to start a fuel cell system (referred to as an “FCS”). The control device sets priorities indicating order of startups on the plurality of FCSs according to the temperature and the required startup power of each of the FCSs, and a remaining capacity of a battery, and start the plurality of FCSs in accordance with the priorities.

### CROSS-REFERENCE TO RELATED APPLICATIONS

This application is based upon and claims the benefit of priority from Japanese Patent Application No. 2024-042000 filed on Mar. 18, 2024, the contents of which are incorporated herein by reference.

### BACKGROUND OF THE INVENTION

### Field of the Invention

The present disclosure relates to an electric power supply system.

### Description of the Related Art

In recent years, research and development have been conducted on fuel cells that contribute to energy efficiency in order to ensure that more people have access to affordable, reliable, sustainable and modern energy.

JP 2017-126441 A discloses an electric power supply system having a plurality of fuel cell systems. The electric power supply system selects one of the fuel cell systems having the highest temperature from the fuel cell systems that are not operating, and starts the selected fuel cell system first.

### SUMMARY OF THE INVENTION

In such an electric power supply system, improvement in the startup responsiveness is desired.

The present disclosure has the object of meeting the aforementioned need.

One aspect of the present disclosure is characterized by an electric power supply system including a secondary battery configured to be connected to a load, a plurality of fuel cell systems configured to be connected to the load and the secondary battery, a control device configured to control startups of the plurality of fuel cell systems and supply of an electric power to the load, a remaining capacity acquisition device configured to acquire a remaining capacity of the secondary battery; and a temperature acquisition device configured to acquire a temperature of each of the fuel cell systems, wherein the control device is configured to calculate a required startup power as an electric power required to start each of the fuel cell systems, set priorities indicating order of startups on the plurality of fuel cell systems in accordance with the temperature and the required startup power of each of the fuel cell systems, and the remaining capacity of the secondary battery, and start the plurality of fuel cell systems in accordance with the priorities.

According to the present disclosure, the startup responsiveness of the electric power supply system can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram illustrating an example of the configuration of the electric power supply system according to an embodiment;

FIG. 2 is a flowchart for describing startup process of the electric power supply system shown in FIG. 1;

FIG. 3 is a flowchart for describing a subroutine that calculates the number of fuel cell systems (FCSs) that can be started;

FIG. 4 is a flowchart for describing a subroutine that sets a startup mode of the FCSs;

FIG. 5 is a flowchart for describing a subroutine that calculates a power value that can be output by the electric power supply system;

FIG. 6 is a flowchart for describing a subroutine that sets a priority in a simultaneous startup mode;

FIG. 7 is a flowchart for describing a subroutine that instructs the FCSs to initiate the startup;

FIG. 8 is a flowchart for describing a subroutine that determines the completion of startup of the electric power supply system;

FIG. 9 is a flowchart illustrating a subroutine that sets priorities in a prioritized startup mode;

FIG. 10 is a flowchart illustrating a subroutine that sets the priority on at least one FCS;

FIG. 11 is an explanatory diagram illustrating an example of a relationship between the temperature of each of the FCSs and the power required for starting each of the FCSs.

FIG. 12A is an explanatory diagram illustrating an example of startup completion timing of the FCSs shown in FIG. 11 and a transition of the power available for starting the FCSs;

FIG. 12B is an explanatory diagram illustrating an example of the priorities set on the FCSs;

FIG. 13 is a timing chart illustrating an example of the timing of the startup completion of the FCSs and the startup completion of the electric power supply system;

FIG. 14 is a flowchart for describing the startup process of the electric power supply system according to the modification; and

FIG. 15 is a flowchart for describing a subroutine that sets the priority on one FCS.

### DETAILED DESCRIPTION OF THE INVENTION

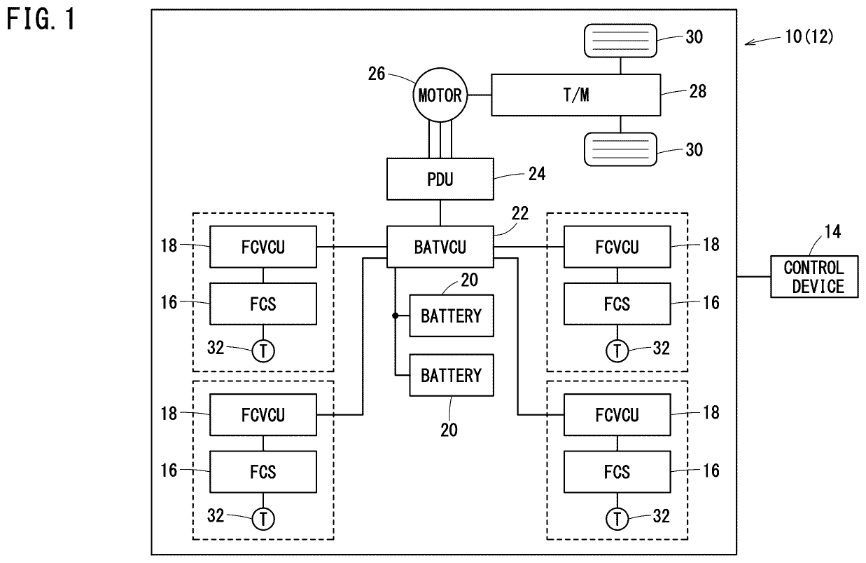

FIG. 1 is a block diagram illustrating an example of the configuration of an electric power supply system 10 according to an embodiment. In this embodiment, the electric power supply system 10 is described as a fuel cell vehicle (FCV) 12 that is propelled (or travels) by the electric power generated by the fuel cell. However, the electric power supply system 10 is not limited to the fuel cell vehicle 12. The electric power supply system 10 may be a moving body other than a vehicle, such as a ship, an aircraft, a robot, or the like. The electric power supply system 10 may be a stationary power source installed in a business facility or a home.

### Configuration of Electric Power Supply System 10

As shown in FIG. 1, the electric power supply system 10 includes a control device 14, a fuel cell system (FCS) 16, a fuel cell voltage control unit (FCVCU) 18, a battery 20, a battery voltage control unit (BATVCU) 22, a power drive unit (PDU) 24, a motor 26, and a transmission (T/M) 28.

The electric power supply system 10 includes a plurality of FCSs 16. Each of the FCSs 16 includes a fuel cell stack and various devices used for the operation of the fuel cell stack.

The fuel cell stack includes a plurality of fuel cells (power generation cells). The plurality of fuel cells generate electric power by electrochemical reactions between a fuel gas and an oxygen-containing gas, and output electric power. Each of the FCSs 16 outputs the electric power output from the fuel cell stack. The electric power output from the FCSs 16 is supplied to a load such as the motor 26 and the like, and is charged to the battery 20.

The FCS 16 includes an auxiliary device (not shown) and a temperature sensor 32 as devices used for the operation of the fuel cell stack.

The auxiliary device supplies a fuel gas and an oxygen-containing gas to the fuel cell stack. The auxiliary device includes a hydrogen tank, an air pump, a coolant system, a valve, piping, and other equipment associated therewith. The FCS 16 may further include a heater for heating the fuel cell stack as the auxiliary device.

The temperature sensor 32 acquires the temperature of the FCS 16 and outputs a signal indicating the acquired result to the control device 14. The temperature of the FCS 16 may be detected, measured, or estimated from, for example, a representative temperature of each power generation cell, a coolant temperature, a temperature of the oxygen-containing gas, and the like. The electric power supply system 10 may adopt a known configuration as a temperature acquisition means of the FCS 16.

The FCS 16 includes various sensors such as a current sensor (not shown) and a voltage sensor (not shown), and has a function of calculating the power that can be currently output by the FCS 16. The FCS 16 outputs a calculated value of the power that can be currently output, to the control device 14. In the following description, the power that the FCS 16 can currently output is referred to as an output possible power Pfc. The FCS 16 has a function of detecting an abnormality in the FCS 16. The FCS 16 outputs a signal indicating the presence or absence of an abnormality in the FCS 16 to the control device 14.

The FCVCU 18 is a boost converter, boosts the voltage of the power output from the FCS 16, and outputs the boosted voltage to the BATVCU 22. The electric power supply system 10 includes one FCVCU 18 for one FCS 16.

The electric power supply system 10 includes at least one battery 20. The battery 20 is a secondary battery that is capable of charging and discharging the electric power. The battery 20 supplies power to a load such as the motor 26 and is charged by the power output from the FCSs 16 and the regenerative electric power of the motor 26.

The battery 20 includes various sensors such as a current sensor (not shown) and a voltage sensor (not shown). The measured values of these sensors are output to the control device 14. The control device 14 estimates the remaining capacity of the battery 20 based on these measured values and the like. That is, the control device 14 functions as a remaining capacity acquisition device of the battery 20. However, the means for acquiring the remaining capacity of the battery 20 is not limited to this configuration, and various known means can be used.

The BATVCU 22 is a buck-boost (step-up/step-down) converter, which boosts and adjusts the voltages of the power output from the battery 20 and the FCVCUs 18, and outputs the adjusted voltage to the PDU 24. The BATVCU 22 adjusts the electric power output from the FCVCU 18 by boosting or lowering the voltage to a voltage suitable for charging the battery 20, and outputs the adjusted electric power to the battery 20.

The PDU24 is an inverter, and converts the input electric power into an electric power having a frequency and a voltage suitable for the rotational speed and the torque of the motor 26, and outputs the converted power to the motor 26.

The motor 26 is an electric motor, operates by the input electric power, and converts the electric power into a driving force (rotational force) and outputs the driving force. The motor 26 is an example of a load that requires the FCS 16 to supply electric power to the load.

The T/M 28 is a transmission, and transmits the rotational force output from the motor 26 to wheels 30 by adjusting the torque.

The control device 14 is a computer that controls the electric power supply system 10. The control device 14 may oversee and control all the components of the electric power supply system 10 and execute the operation of the electric power supply system 10.

For example, the control device 14 is equipped with a computation unit (processing unit) and a storage unit.

The computation unit may be configured by a processor such as a central processing unit (CPU) or a graphics processing unit (GPU). More specifically, the computation unit can be configured by a processing circuitry.

The computation unit includes functional units such as a determination unit, a battery remaining capacity acquisition unit, a power calculation unit, a startup mode setting unit, a priority setting unit, a startup initiation determination unit, and an output limiting unit. These functional units can be realized by the computation unit executing computer-executable instructions (programs) stored in the storage unit.

It should be noted that at least a portion of the computation unit may be implemented by an integrated circuit such as an application specific integrated circuit (ASIC) or a field-programmable gate array (FPGA). Further, at least a portion of the computation unit may be configured by an electronic circuit including a discrete device.

The storage unit may be configured by a non-illustrated volatile memory, and a non-illustrated non-volatile memory. As the non-volatile memory, there may be cited, for example, a read only memory (ROM), a flash memory, or the like. The non-volatile memory is used as a storage memory, and stores therein programs, tables, maps, and the like. As the volatile memory, there may be cited, for example, a random access memory (RAM). The volatile memory is used as a working memory of the processor, and temporarily stores data or the like necessary for processing or calculations. At least a portion of the storage unit may be provided in the processor, the integrated circuit, or the like, which were described above.

### Description of Operation Relating to Startup Process of Electric Power Supply System 10

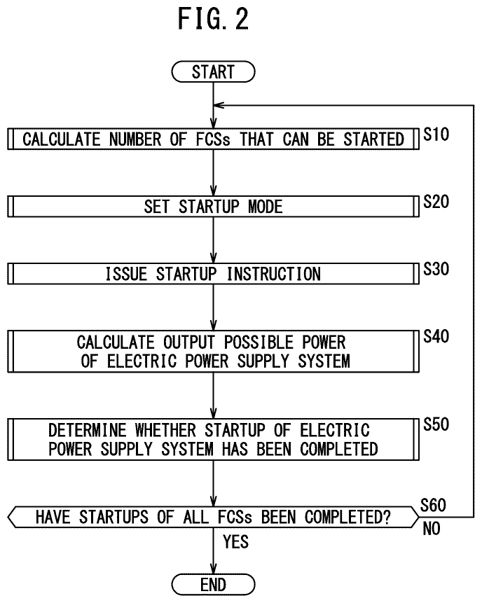

The electric power supply system 10 is basically configured as described above. Next, the operation of the electric power supply system 10 in the startup process will be described with reference to the flowchart of FIG. 2 and so on.

FIG. 2 is a flowchart for describing the startup process of the electric power supply system 10 shown in FIG. 1. The control device 14 starts the startup process of the electric power supply system 10 when receiving a startup instruction such as an instruction to start the operation of the fuel cell vehicle 12 from a user.

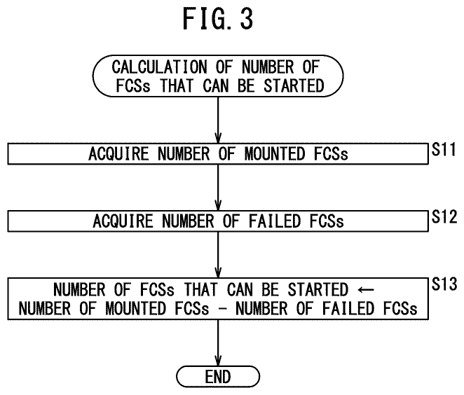

In step S10, the control device 14 calculates the number of FCSs 16 that can be started (hereinafter, the number of FCSs 16 is also referred to as the number of fuel cell systems). A subroutine called in step S10 is shown in FIG. 3.

FIG. 3 is a flowchart illustrating a subroutine for calculating the number of FCSs 16 that can be started. In step S11 of FIG. 3, the control device 14 acquires the number of FCSs 16 mounted in the electric power supply system 10. The control device 14 can acquire, for example, the number of FCSs 16 mounted in the electric power supply system 10 that is stored in the storage unit in advance from the storage unit.

In step S12, the control device 14 acquires the number of the failed FCSs 16. For example, the control device 14 inquires of each of the FCSs 16 about the presence or absence of a failure. The control device 14 may acquire the number of failed FCSs 16 based on the number of abnormal signals received from each of the FCSs 16. The abnormality of the FCS 16 means a state in which the FCS 16 cannot be normally started, and includes, for example, a failure of an air pump or a valve, a cross leak in the fuel cell stack, and the like.

In step S13, the control device 14 subtracts the number of failed FCSs 16 from the number of FCSs 16 that are mounted, to calculate the number of FCSs 16 that can be started. At this time, the control device 14 may acquire the address of each of the FCSs 16 and identify the FCSs 16 that can be normally started.

After step S13, the control device 14 performs the startup process for the normal FCSs 16. That is, in step S13, the control device 14 excludes the failed FCSs 16 from the target of the startup process of the electric power supply system 10. In the following description, the term “FCS 16” (or FCSs 16) is used to mean an “FCS 16 that can be normally started” unless otherwise specified.

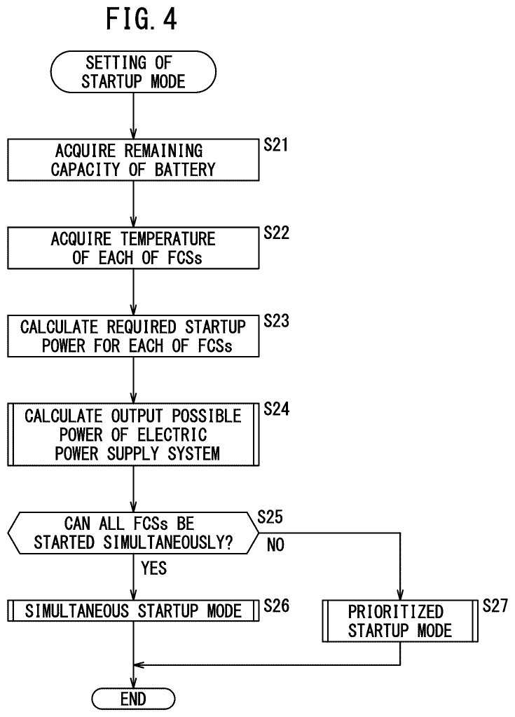

Returning to the process shown in FIG. 2, the control device 14 sets the startup mode of the FCS 16 in step S20. The subroutine called in step S20 is shown in FIG. 4.

FIG. 4 is a flowchart for describing a subroutine that sets a startup mode of the FCS 16. In step S21 of FIG. 4, the control device 14 acquires the remaining capacity of the battery 20. The control device 14 can acquire the remaining capacity of the battery 20 based on the measured values of a current sensor (not shown), a voltage sensor (not shown), and the like provided in the battery 20, and a map stored in the storage unit and the like.

In step S22, the control device 14 acquires the temperatures of the FCSs 16 from the temperature sensors 32.

In step S23, the control device 14 calculates the power value required for each of the FCSs 16 based on the temperature of each of the FCSs 16. The control device 14 can calculate the power value required for starting the FCS 16, for example, from the temperature of the FCS 16 and the map stored in the storage unit. In the following description, the power value required for starting the FCS 16 is expressed as “required startup power Preq”.

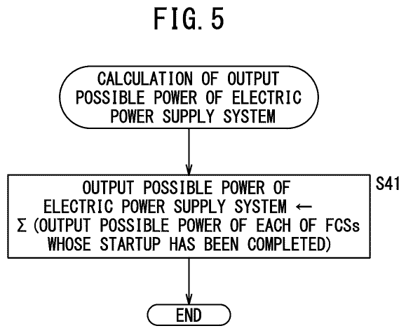

In step S24, the control device 14 calculates a power value that can be output by the electric power supply system 10. The subroutine called in step S24 is shown in FIG. 5.

FIG. 5 is a flowchart for describing a subroutine that calculates the power value that can be output by the electric power supply system 10. In step S41 of FIG. 5, the control device 14 calculates a power value that can be output by the electric power supply system 10. Hereinafter, the power value that can be output by the electric power supply system 10 is referred to as an “output possible power Pall”. The control device 14 may calculate, for example, the sum of the output possible powers Pfc of the FCSs 16, and may set the sum as the output possible power Pall of the electric power supply system 10 (Pall=ΣPfc).

The output possible power Pfc that the FCS 16, which has not been started, can output is 0 (zero). Therefore, in the initial state, the output possible power Pall of the electric power supply system 10 is also 0 (zero).

Returning to the process shown in FIG. 4, the control device 14 determines whether all the FCSs 16 can be started at the same time in step S25. The control device 14 can determine whether or not to perform the simultaneous startup based on, for example, the remaining capacity of the battery 20 and the required startup power Preq of each of the FCSs 16.

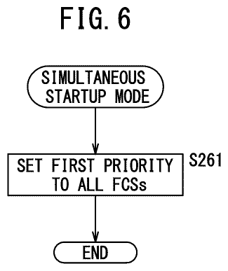

If the battery 20 has sufficient remaining capacity and is capable of supplying the required startup power Preq to all the FCSs 16, the control device 14 may determine that all the FCSs 16 can be started simultaneously (step S25: YES). In this case, the control device 14 transitions to the simultaneous startup mode in step S26. The subroutine called in step S26 is shown in FIG. 6.

FIG. 6 is a flowchart for describing a subroutine that sets a priority in a simultaneous startup mode. The priorities of the FCSs 16 mean the order in which the FCSs 16 are started. That is, the FCS 16 on which a higher priority is set is started earlier than another FCS 16 with precedence. In the following description, the term an “nth priority” is sometimes used to indicate the order or sequence of startup, and both the “priority n” and the “nth priority” are used in the same sense.

The electric power supply system 10 according to the present embodiment allows the same priority to be set on a plurality of FCSs 16. For example, in the case that the same priority is set on the plurality of FCSs 16, the plurality of FCSs 16 are started simultaneously.

When the control device 14 transitions to the simultaneous startup mode, the control device 14 sets a “priority 1” on all the FCSs 16 in step S261 of FIG. 6. The priority 1 means the “first priority”. That is, in the simultaneous startup mode, all the FCSs 16 can be started simultaneously.

The process returns to step S25 in FIG. 4, for example, in the case that the remaining capacity of the battery 20 is small, the battery 20 cannot supply the required startup power Preq to all the FCSs 16. The control device 14 may determine that all the FCSs 16 cannot be started simultaneously (step S25: NO).

In this case, the control device 14 transitions to the prioritized startup mode in step S27. In the prioritized startup mode, at least one FCS 16 is selected based on the temperature, and the selected FCS 16 is sequentially started with precedence over the other FCSs 16. The details of the prioritized startup mode will be described later.

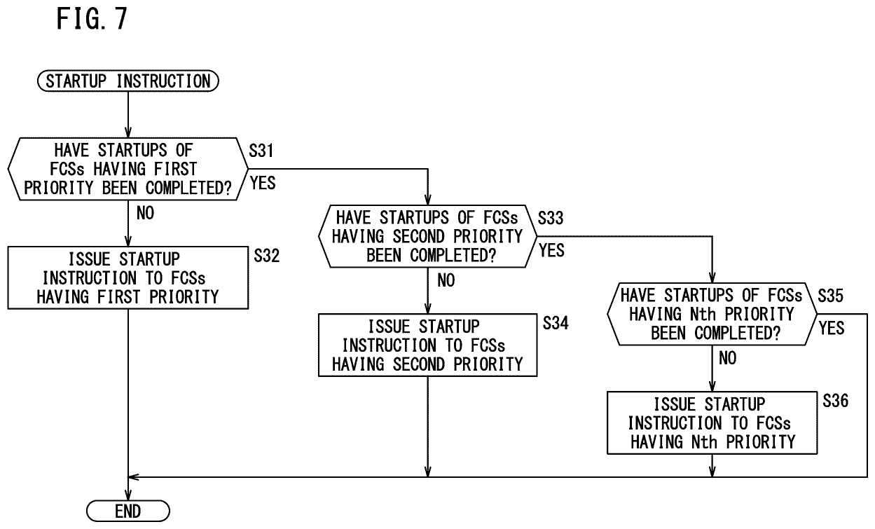

Returning to the process shown in FIG. 2, the control device 14 issues a startup instruction (startup request) corresponding to the startup mode to each of the FCSs 16 in step S30. In this instance, the description will be continued on the assumption of the “simultaneous startup mode”. That is, the description will be given on the assumption that the “priority 1 (first priority)” is set for all the FCSs 16. The subroutine called in step S30 is shown in FIG. 7.

FIG. 7 is a flowchart for describing a subroutine that instructs the FCS to initiate the startup. The control device 14 instructs the FCSs 16 to start in accordance with the priorities.

In step S31, the control device 14 determines whether the startups of the FCSs 16, to which the “priority 1 (first priority)” has been assigned, have been completed. The startup completion of the FCS 16 can be determined, for example, by checking whether the temperature of the FCS 16 is equal to or higher than a predetermined value (for example, equal to or higher than 80 degrees Celsius). In this instance, the description will be continued on the assumption that the FCSs 16 to which the “priority 1 (first priority)” has been assigned, have not been started yet (step S31: NO).

In step S32, the control device 14 issues a startup instruction to the FCSs 16 to which the “priority 1 (first priority)” has been assigned. In this instance, since it is assumed that “the first priority” has been set on all the FCSs 16, all the FCSs 16 that can be normally started begin the startup process simultaneously.

Returning to the process shown in FIG. 2, the control device 14 calculates the output possible power Pall of the electric power supply system 10 in step S40. The subroutine called in step S40 is shown in FIG. 5.

In step S41, the control device 14 sets the sum of the output possible power Pfc of each of the FCSs 16 whose startup has been completed, as the output possible power Pall of the electric power supply system 10. In this instance, since each of the FCSs 16 is immediately after the startup has been initiated, the output possible power Pfc is 0, and the output possible power Pall of the electric power supply system 10 is 0.

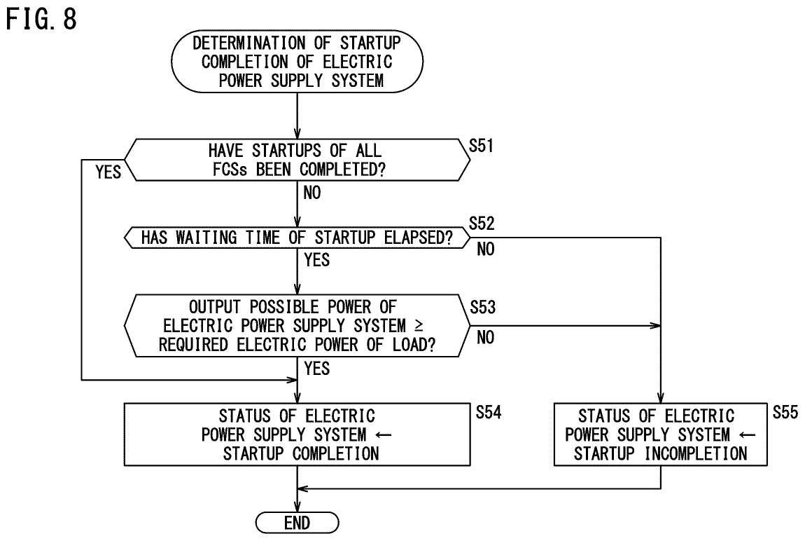

Returning to the process shown in FIG. 2, the control device 14 determines whether the startup of the entire electric power supply system 10 has been completed in step S50. The subroutine called in step S50 is shown in FIG. 8.

FIG. 8 is a flowchart for describing a subroutine that determines the completion of startup of the electric power supply system 10. In step S51 of FIG. 8, the control device 14 determines whether or not the startups of all the FCSs 16 have been completed.

If the startups of all the FCSs 16 are not completed (step S51: NO) and a waiting time of startup has not elapsed (step S52: NO), a “startup incompletion flag” is set as a status flag of the electric power supply system 10 in step S55.

In this case, returning to the process shown in FIG. 2, and it is again determined in step S60 that the startups of all the FCSs 16 have not been completed (step S60: NO). Returning to step S10, the startup process of the FCSs 16 is repeatedly executed until the startups of all the FCSs 16 are completed.

In the case that it is determined in step S51 of FIG. 8 that the startups of all the FCSs 16 have been completed (step S51: YES), the “startup completion flag” is set in the status flag of the electric power supply system 10 in step S54.

In this case, returning to the process shown in FIG. 2, and it is again determined in step S60 that the startups of all the FCSs 16 have been completed (step S60: YES). The startup process of the electric power supply system 10 is completed. The electric power supply system 10 may start operating to supply electric power to the load.

In step S51 of FIG. 8, even if the startups of all the FCSs 16 have not been completed (step S51: NO), in the case that the waiting time of startup has elapsed (step S52: YES) and the output possible power Pall of the electric power supply system 10 has reached the required electric power of the load or more (step S53: YES), the control device 14 sets the “startup completion flag” as the status flag of the electric power supply system 10 (step S54).

In this case, the electric power supply system 10 may start operating to supply electric power to the load by the output possible power Pfc of the FCSs 16 that have been started. On the other hand, the startup process for the FCSs 16 that have not been started is repeatedly performed until the startups of all the FCSs 16 are completed.

In this way, the electric power supply system 10 according to the present embodiment can start to supply electric power to the load within the range of the output possible power Pfc of the FCSs 16 that have been started, without waiting for the completion of startups of all the FCSs 16. That is, the electric power supply system 10 can start to supply electric power more quickly than in the case where the supply of electric power is started after the startups of all the FCSs 16 have been completed.

### Description of Prioritized Startup Mode

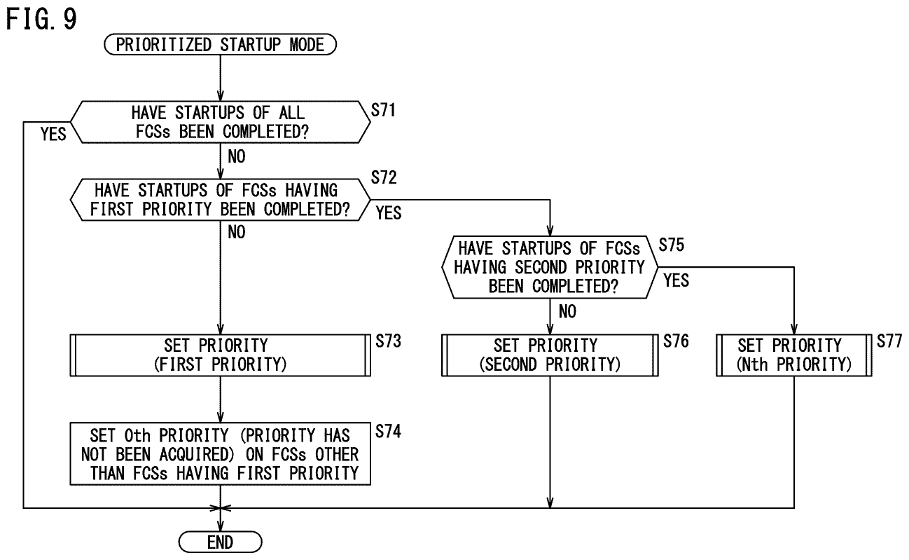

Next, the “prioritized startup mode” will be described in detail with reference to FIGS. 4, 9, and 10. The “prioritized startup mode” is a mode to which the process transitions in the case that it is determined in step S25 of FIG. 4 that the simultaneous startups of all the FCSs 16 are not possible. The subroutine called in step S27 of FIG. 4 is shown in FIG. 9.

FIG. 9 is a flowchart illustrating a subroutine that sets the priorities in a prioritized startup mode.

In step S71 of FIG. 9, the control device 14 determines whether the startups of all the FCSs 16 have been completed. In this case, it is assumed that none of the FCSs 16 have initiated the startup, and it is determined that the startups of all the FCSs 16 have not been completed (step S71: NO).

In step S72, the control device 14 determines whether the startup of the FCS 16 to which the “priority 1 (first priority)” is assigned has been completed. In this instance, it is assumed that there is no FCS 16 to which the “first priority” is assigned, and it is determined that the startup of the FCS 16 to which the “first priority” is assigned has not been completed (step S72: NO).

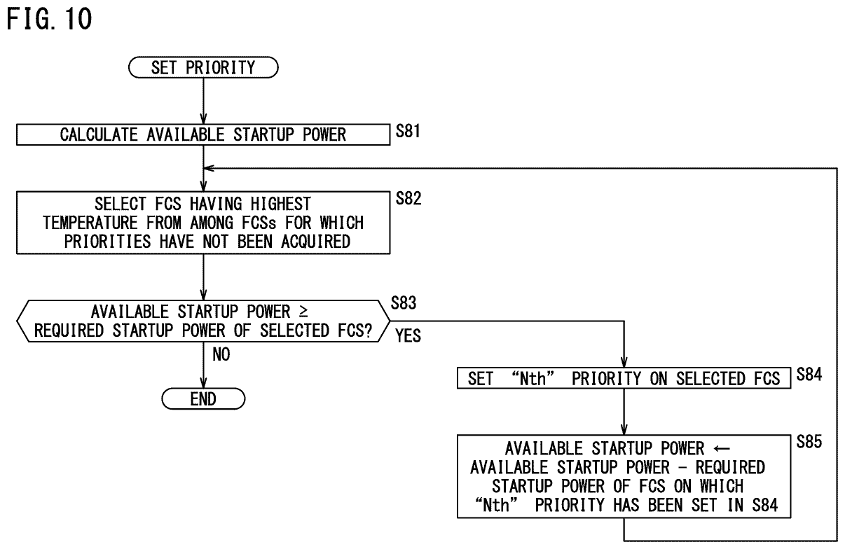

In step S73, the control device 14 sets the “priority 1 (first priority)” on at least one FCS 16. The subroutine called in step S73 is shown in FIG. 10.

FIG. 10 is a flowchart illustrating a subroutine for setting the priority on at least one FCS 16.

In step S81 of FIG. 10, the control device 14 calculates the power available to start the FCSs 16. The power available to start the FCSs 16 is hereinafter referred to as a “available startup power Pavb1”.

The available startup power Pavb1 is basically the power that the battery 20 can supply to the FCSs 16. However, in the case that there is an FCS 16 that has already been started, it is preferable that the power (output possible power Pfc) that can be output by the FCS 16 that has been started be also used for the startups of other FCSs 16. That is, the available startup power Pavb1 may include the output possible power Pfc of the FCS 16 that has been started.

In step S82, the control device 14 selects one FCS 16 having the highest temperature from among the plurality of FCSs 16 on which no priority is set. Since an FCS 16 having a high temperature requires a short heating time by, for example, a heater, the power consumption required for the startup is small, and it is expected that the startup can be performed in a short time. In the following description, the FCS 16 on which the priority is not set may be referred to as the FCS 16 for which the priority has not been acquired yet.

To facilitate description, the FCS 16 selected first in step S82 is denoted as an FCS 16-1, and the FCS 16 selected Mth is denoted as an FCS 16-M. Here, the description will be continued with respect to the case where M=1, that is, the FCS 16-1 selected first.

In step S83, the control device 14 determines whether the available startup power Pavb1 available for starting the FCS 16-1 is equal to or greater than the required startup power Preq necessary for starting the FCS 16-1. In the case that the available startup power Pavb1 is equal to or more than the required startup power Preq of the FCS 16-1 (step S83: YES), the “priority N (Nth priority)” is set on the FCS 16-1 in step S84. In the following description, it is assumed that the priority 1 (first priority) is set on the FCS 16-1 by the control device 14 when N=1.

In step S85, the control device 14 subtracts the required startup power Preq of the FCS 16-1 on which the “priority 1 (first priority)” is set, from the available startup power Pavb1. The control device 14 sets a value after subtraction as a new available startup power Pavb1.

Returning to step S82, the control device 14 selects one FCS 16-2 having the highest temperature from among the plurality of FCSs 16 on which no priority is set.

In step S83, in the case that the new available startup power Pavb1 is equal to or more than the required startup power Preq of the FCS 16-2 (step S83: YES), the “priority 1 (first priority)” is set on the FCS 16-2 in step S84. That is, the control device 14 sets the “priority 1 (first priority)” on the two FCSs 16, i.e., the FCS 16-1 and the FCS 16-2. In step S85, the control device 14 updates the value of the available startup power Pavb1, and returns the process to step S82.

In this way, the processing of steps S82 to S85 is repeatedly executed on the condition that the available startup power Pavb1 is equal to or more than the required startup power Preq of the FCS 16-M. As a result, the “priority 1 (first priority)” is set on one FCS 16, or two or more but not more than M FCS 16.

When the available startup power Pavb1 becomes less than the required startup power Preq of the FCS 16-M (step S83: NO), it is determined that the remaining capacity of the battery 20 cannot cover the required startup power Preq of the FCS 16-M, and the setting process of the “priority 1 (first priority)” is ended.

Returning to the process shown in FIG. 9, in step S74, the control device 14 sets a “priority 0 (0th priority)” on the FCSs 16 other than the FCSs 16 on which the “priority 1 (first priority)” has been set. The “priority 0 (0th priority)” means a state in which the priority has not been acquired, that is, the FCSs are in the waiting state for the priorities to be set.

Returning to the process shown in FIG. 2, the control device 14 calls the subroutine shown in FIG. 7 in step S30.

In steps S31 and S32 of FIG. 7, the control device 14 issues an startup instruction to the M FCSs 16-1 to 16-M on which the “priority 1 (first priority)” is set.

Returning to the process shown in FIG. 2, the control device 14 calls the subroutine shown in FIG. 5 in step S40. In step S41 of FIG. 5, the control device 14 calculates the output possible power Pall of the electric power supply system 10.

Returning to the process shown in FIG. 2, the control device 14 calls the subroutine shown in FIG. 8 in step S50. The control device 14 determines whether the startup of the electric power supply system 10 has been completed based on the subroutine shown in FIG. 8. In the case that the predetermined condition is satisfied (step S53: YES), the supply of electric power to the load can be started.

The control device 14 repeatedly executes the startup process in the prioritized startup mode (step S60: NO) until the startups of all the FCSs 16 are completed, regardless of whether the supply of electric power to the load has been started or not.

That is, in the prioritized startup mode, when the FCSs 16 on which the priority 1 (first priority) is set have completed the startups (step S72 in FIG. 9: YES), the control device 14 sets the priority 2 (second priority) on at least one FCS 16 (step S75: NO, step S76), and issues an instruction to start (step S33, step S34). The control device 14 sets the “priority N (Nth priority)” on at least one FCS 16 (step S77) and issues instructions to start (steps S35 and S36) by repeatedly performing the similar processes.

The control device 14 repeatedly executes the processing of steps S82 to S85 of FIG. 10 on the condition that the available startup power Pavb1 is equal to or more than the required startup powers Preq of the FCSs 16. In this manner, a higher priority is set on at least one FCS 16 in descending order of temperature, and the at least one FCS 16 can initiate startup in accordance with the priority.

In this way, in the prioritized startup mode, even under the situation where the remaining capacity of the battery 20 is insufficient, at least one FCS 16 having a high temperature is started with precedence within the range of the remaining capacity of the battery 20, so that the electric power supply system 10 can be quickly started.

### Example of Startup Process in Prioritized Startup Mode

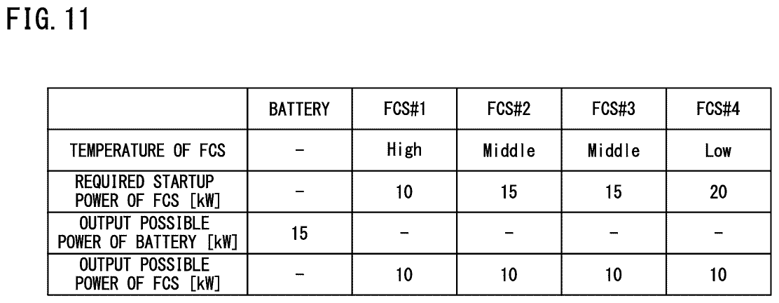

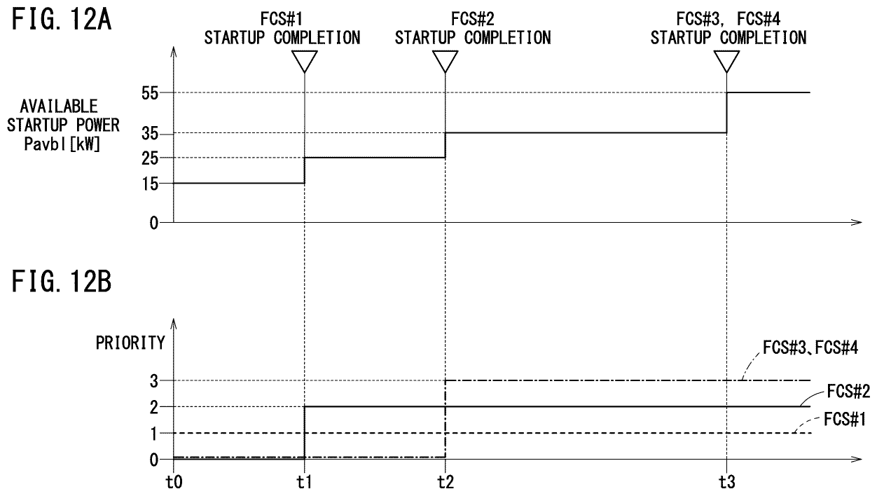

Next, an example of the startup process in the prioritized startup mode will be described in time series with reference to FIGS. 11 and 12.

FIG. 11 is an explanatory diagram illustrating an example of a relationship between the temperature of each of the four FCSs 16 and the required startup power Preq [KW] required for starting each of the FCSs 16. In order to distinguish the four FCSs 16 from each other, the names FCS #1, FCS #2, FCS #3, and FCS #4 are used in FIG. 11, respectively. As shown in the second and third rows of FIG. 11, the higher the temperature of the FCS 16 is, the smaller the required startup power Preq is, and the lower the temperature of the FCS 16 is, the greater the required startup power Preq is.

The fourth row of FIG. 11 shows the power [KW] that can be output by the battery 20, and the fifth row shows the output possible power Pfc [KW] that can be output by each of the FCSs 16 after the startup. The total value of the power that can be output by the battery 20 and the output possible power Pfc by each of the FCSs 16 corresponds to the available startup power Pavb1 [KW] calculated in step S81 of FIG. 10. That is, the available startup power Pavb1 is the power available for the electric power supply system 10 to start the FCSs 16 that have not been started.

FIG. 12A is an explanatory diagram illustrating an example of startup completion timing of the FCSs 16 (FCS #1 to FCS #4) shown in FIG. 11 and a transition of the available startup power Pavb1. FIG. 12B is an explanatory diagram illustrating an example of the priority set on each of the FCSs 16.

At time to in FIGS. 12A and 12B, the startup process of the electric power supply system 10 is initiated. At time to, none of the four FCSs 16 is started.

As shown in FIG. 11, the output electric power (15 kW) of the battery 20 is smaller than the sum of the required startup powers Preq of the four FCSs 16 (10 kW+15 kW+15 kW+20 kW=60 KW). That is, the battery 20 cannot supply the electric power necessary for starting the four FCSs 16 simultaneously (in FIG. 4, step S25: NO). Therefore, the control device 14 transitions to the prioritized startup mode.

When the output electric power of the battery 20 (15 kW) and the required startup power Preq (10 KW) of the FCS #1 having the highest temperature are compared, the former is greater than the latter (in FIG. 10, step S83: YES). Therefore, as shown in FIG. 12B, at time to, the control device 14 sets the “priority 1 (first priority)” on the FCS #1.

The value acquired by subtracting the required startup power Preq (10 KW) of the FCS #1 from the output electric power (15 kW) of the battery 20 is 5 kW. The value 5 kW is smaller than the required startup power Preq (15 KW) of the FCS #2 having the second highest temperature. The same applies to the FCS #3 having the same temperature as the FCS #2. That is, the battery 20 cannot supply the power necessary for starting the FCS #2, or supply the power necessary for starting the FCS #3. The control device 14 sets the “priority 0 (0th priority)” on the three FCSs other than the FCS #1, and instructs the FCS #1 to initiate the startup.

When the startup of the FCS #1 is completed at time t1, the available startup power Pavb1 is increased by the output possible power Pfc (10 KW) of the FCS #1 to be 25 kW. The electric power supply system 10 can cover the required startup power Preq (15 kW) of the FCS #2 with the new available startup power Pavb1 (step S83: YES). The “priority 2 (second priority)” is set on the FCS #2, and the startup of the FCS #2 is initiated.

When the startup of the FCS #2 is completed at time t2, the available startup power Pavb1 is further increased by the output possible power Pfc (10 KW) of the FCS #2 to be 35 kW. The electric power supply system 10 can cover the required startup power Preq (15 kW) of the FCS #3 and the required startup power Preq (15 kW) of the FCS #4 with the new available startup power Pavb1 (step S83: YES). The “priority 3 (third priority)” is set on the FCS #3 and the FCS #4, and the startup of the FCS #3 and the FCS #4 is initiated.

When the startups of the FCS #3 and the FCS #4 are completed at time t3, the available startup power Pavb1 is increased by the output possible power Pfc (10 KW) of the FCS #3 and the output possible power Pfc (10 KW) of the FCS #4 to be 55 kw. When the startups of all the four FCSs 16 are completed (step S60: YES), the control device 14 terminates the startup process of the electric power supply system 10.

### Example of Determination Process for Startup Completion of Electric Power Supply System

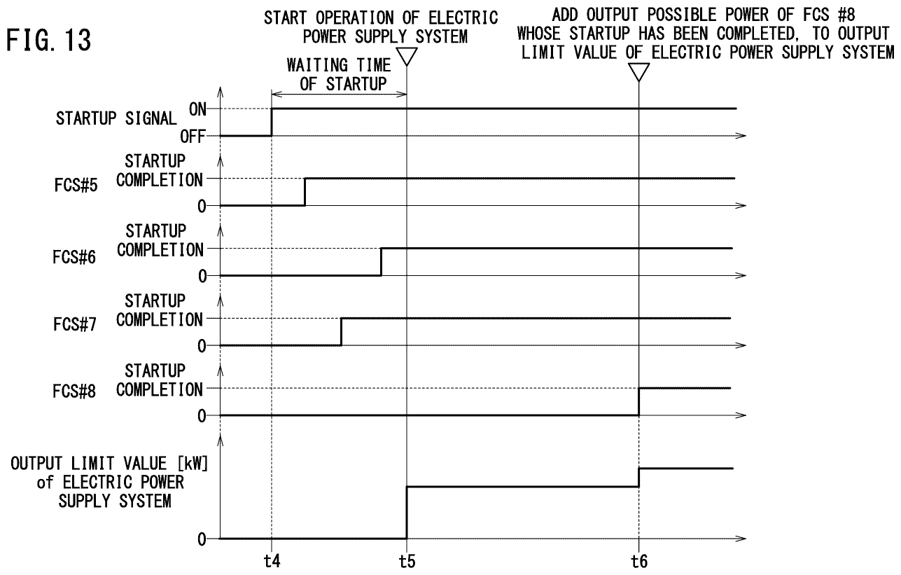

Next, with reference to FIG. 13, an example of a process in which the control device 14 determines the startup completion of the electric power supply system 10 will be described in time series.

FIG. 13 is a timing chart illustrating an example of the timing of the startup completion of the four FCSs 16 and the startup completion of the electric power supply system 10. In order to distinguish the four FCSs 16 from each other, the names FCS #5, FCS #6, FCS #7, and FCS #8 are used in FIG. 13, respectively.

At time t4, the control device 14 receives the startup signal (startup request) of the electric power supply system 10 from the load, and initiates the startup process of the electric power supply system 10. The control device 14 instructs each of the FCS 16 to initiate the startup in, for example, the prioritized startup mode. However, the control device 14 may issue an instruction to initiate the startup in the simultaneous startup mode.

At time t5, the waiting time of startup elapses. At time t5, the three FCSs 16, i.e., the FCS #5, the FCS #7, and the FCS #6, have completed the startup, and the FCS #8 has not been started yet.

The control device 14 sums up the output possible powers Pfc [KW] of the three FCS #5, FCS #7, and FCS #6 whose startups have been completed, and calculates the total value (step S41 in FIG. 5). This total value corresponds to the output possible power Pall [KW] that can be output by the electric power supply system 10. In the case that the output possible power Pall of the electric power supply system 10 is equal to or greater than the required electric power of the load (in FIG. 8, step S53: YES), the control device 14 sets the “startup completion flag” as the status flag of the electric power supply system 10.

When the startup completion flag is set, the control device 14 can determine that the startup process of the electric power supply system 10 has been completed. The control device 14 increases an output limit value [KW] of the electric power supply system 10 from 0 to the output possible power Pall. In other words, the control device 14 relaxes the output limit of the electric power supply system 10. The electric power supply system 10 can thereby start to supply electric power to the load. However, the startup process for the FCS #8 that has not been started is continuously performed.

At time t6, when the startup of FCS #8 is completed, the control device 14 adds the output possible power Pfc of the FCS #8 to the output possible power Pall of the electric power supply system 10. The electric power supply system 10 increases the output limit value [KW] to the output possible power Pall after addition. In accordance with this feature, the electric power supply system 10 is capable of supplying electric power to the load at the maximum output. When the startups of all the four FCSs 16 are completed, the control device 14 terminates the startup process of the electric power supply system 10.

The temperature and the tendency to be heated of the FCSs 16 may vary depending on the installation location of the FCSs 16. However, the electric power supply system 10 according to the present embodiment can start to supply electric power to the load when the output possible power Pall reaches the required electric power of the load. The supply of electric power can be started immediately without waiting for the startup completion of all the FCSs 16.

### Description of Modifications

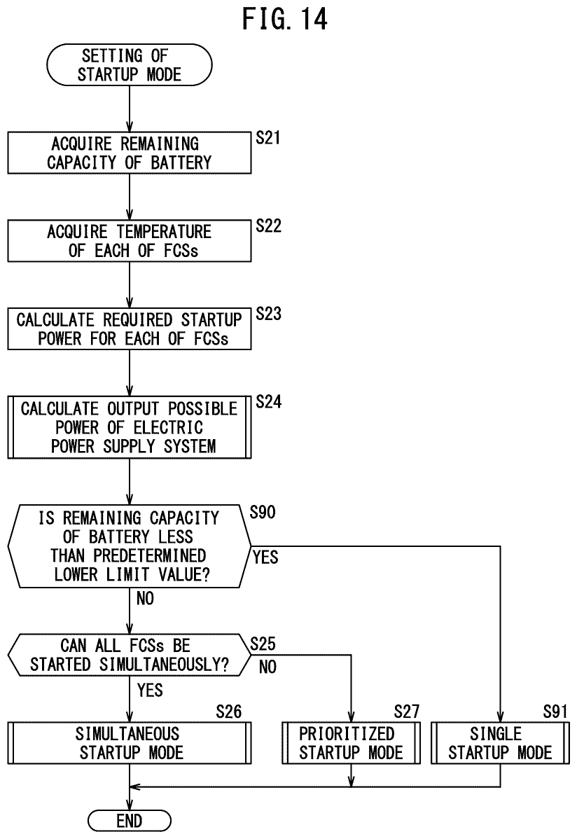

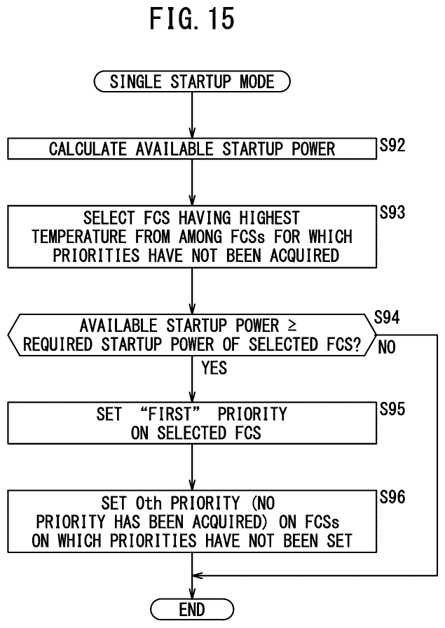

Next, an electric power supply system 100 according to the modification will be described with reference to FIGS. 14 and 15. The electric power supply system 100 according to the modification differs from the electric power supply system 10 according to the embodiment in that the electric power supply system 100 has a “single startup mode” in addition to the “simultaneous startup mode” and the “prioritized startup mode”. The constituent elements and the processes that are common to those of the electric power supply system 10 according to the embodiment are labeled with the same reference numerals, and detailed description thereof is omitted.

FIG. 14 is a flowchart for describing the startup process of the electric power supply system 100 according to the modification.

In step S90 of FIG. 14, the control device 14 determines whether the remaining capacity of the battery 20 is less than a predetermined lower limit value. The predetermined lower limit value is, for example, a value indicating a lower limit of capacity for normal use of the battery 20. As a case where it is determined that the remaining capacity of the battery 20 is less than the predetermined lower limit value, it is assumed here that the remaining capacity of the battery 20 is extremely small, for example.

In the case that it is determined in step S90 that the remaining capacity of the battery 20 is less than the predetermined lower limit value (step S90: YES), the control device 14 transitions to the single startup mode in step S91. The subroutine called in step S91 is shown in FIG. 15.

FIG. 15 is a flowchart for describing a subroutine that sets the priority 1 (first priority) on one FCS 16 according to the modification.

In step S92, the control device 14 calculates an available startup power Pavb1 that can be used to start the FCS 16. The available startup power Pavb1 is basically the power that the battery 20 can supply to the FCS 16. In steps S93 and S94, the control device 14 selects only the FCS 16 having the highest temperature within the range of the remaining capacity of the battery 20. In step S95, the control device 14 sets the “priority 1 (first priority)” on the selected FCS 16. In step S96, the control device 14 sets the “priority 0 (0th priority)” on the other FCSs 16, and ends the subroutine.

While the remaining capacity of the battery 20 is less than the predetermined lower limit value (step S90 in FIG. 14: YES), the control device 14 repeatedly executes the startup process in the single startup mode (step S60 in FIG. 2: NO) until the startups of all the FCSs 16 are completed.

That is, in the single start mode, the control device 14 sets “priority 1 (first priority)” on the FCS 16 having the highest temperature. When the startup of the FCS 16 set with the “priority 1 (first priority)” is completed, the “priority 1 (first priority)” is set again on the FCS 16 having the next highest temperature. In the single startup mode, the same priority is not set on any of the plurality of FCSs 16, as in the prioritized startup mode. Among the FCSs 16 that have not been started, the FCS 16 having the highest temperature is started solely. The output possible powers Pfc of the FCSs 16 whose startups have been completed are used for the startup process of the FCS 16 to be started next.

As described above, in the single startup mode, the electric power supply system 100 according to the modification can initiate the startup one by one in order from the FCS 16 having the highest temperature. In accordance with this feature, it is possible to quickly start the electric power supply system 100 while suppressing electrical power consumption associated with the startup of the FCSs 16.

In the single startup mode, the battery 20 may be charged with the output possible powers Pfc of the FCS 16 whose startups have been completed. In the case that the remaining capacity of the battery 20 becomes equal to or more than the lower limit value of capacity for normal use, the mode may transition from the single startup mode to the prioritized startup mode. In accordance with this feature, it is possible to quickly start the electric power supply system 100.

With respect to the above disclosure, the following supplementary notes are disclosed.

### Supplementary Note 1

The electric power supply system (10, 100) according to the present disclosure includes the secondary battery (20) configured to be connected to the load (26), the plurality of fuel cell systems (16) configured to be connected to the load and the secondary battery, the control device (14) configured to control the startups of the plurality of fuel cell systems and supply of the electric power to the load, the remaining capacity acquisition device (14) configured to acquire the remaining capacity of the secondary battery, and the temperature acquisition device (32) configured to acquire the temperature of each of the fuel cell systems, wherein the control device is configured to calculate the required startup power (Preq) as the electric power required to start each of the fuel cell systems, set the priorities indicating order of startups on the plurality of fuel cell systems in accordance with the temperature and the required startup power of each of the fuel cell systems, and the remaining capacity of the secondary battery, and start the plurality of fuel cell systems in accordance with the priorities.

In accordance with such a configuration, the electric power supply system can reflect the current status of the electric power supply system and can preferentially start each of the fuel cell systems suitable for the status. In accordance with this feature, the startup responsiveness of the electric power supply system can be improved.

### Supplementary Note 2

In the electric power supply system according to Supplementary Note 1, the control device may be configured to set the same priority on the plurality of fuel cell systems in the case that the remaining capacity of the secondary battery is equal to or greater than the predetermined value, and start the plurality of fuel cell systems simultaneously.

In accordance with such a configuration, in a status where the secondary battery has a sufficient remaining capacity, the electric power supply system can set the same priority on the plurality of fuel cell systems and simultaneously start the plurality of fuel cell systems, reflecting the status. In accordance with this feature, it is possible to quickly start the electric power supply system.

### Supplementary Note 3

In the electric power supply system according to Supplementary Note 1, the control device may be configured to select, in the case that the remaining capacity of the secondary battery is less than the predetermined value, at least one fuel cell system having the highest temperature from among the fuel cell systems that have not been started, and set a higher priority on the selected at least one fuel cell system than the other fuel cell system, and start the selected at least one fuel cell system with precedence over the other fuel cell system.

In accordance with such a configuration, in the status where the remaining capacity of the secondary battery is insufficient, the electric power supply system selects the fuel cell system to be started in consideration of the status. That is, the number of fuel cell systems to be started is limited, and the fuel cell system having a high temperature can be started with priority. In accordance with this feature, it is possible to quickly start the electric power supply system.

### Supplementary Note 4

In the electric power supply system according to Supplementary Note 3, the control device may be configured to, in a case that at least two fuel cell systems are selected from among the fuel cell systems that have not been started, set the same priority on the selected at least two fuel cell systems, on the condition that the total value of the required startup powers of the selected at least two fuel cell systems is less than the remaining capacity of the secondary battery, and start the selected at least two fuel cell systems with precedence over the other fuel cell system.

In accordance with such a configuration, even under a status where the remaining capacity of the secondary battery is insufficient, the electric power supply system allows a plurality of fuel cell systems to be started simultaneously within the range of the remaining capacity of the secondary battery. That is, the number of fuel cell systems to be started can be increased within the range of the remaining capacity of the secondary battery. In accordance with this feature, it is possible to quickly start the electric power supply system.

### Supplementary Note 5

In the electric power supply system according to Supplementary Note 3, the control device may be configured to, after the startup of the at least one fuel cell system from among the plurality of the fuel cell systems has been completed, set the priorities in accordance with the temperature and the required startup power of each of the fuel cell systems, the remaining capacity of the secondary battery, and an output electrical power (Pfc) of the at least one fuel cell system whose startup has been completed, and start any of the fuel cell systems that have not been started by using at least one of the electric power supplied from the secondary battery or the output electric power of the at least one fuel cell system whose startup has been completed.

In accordance with such a configuration, in a status where at least one fuel cell system has completed the startup, the electric power supply system can reflect the output electric power of the fuel cell system that has completed the startup and start the fuel cell system that has not started yet. In accordance with this feature, it is possible to quickly start the electric power supply system.

### Supplementary Note 6

In the electric power supply system according to Supplementary Note 1, the control device may be configured to select, in the case that the remaining capacity of the secondary battery is smaller than the predetermined value that indicates the lower limit of capacity for normal use of the secondary battery, the first fuel cell system having the highest temperature from among the plurality of fuel cell systems that have not been started, set the higher priority on the selected first fuel cell system than other fuel cell systems, start only the selected first fuel cell system by using the electric power supplied from the secondary battery, select, after completing the startup of the first fuel cell system, the second fuel cell system having the second highest temperature from among the plurality of fuel cell systems that have not been started, and start the second fuel cell system by using the output electric power of the first fuel cell system.

In accordance with such a configuration, in a status where the remaining capacity of the secondary battery is smaller than the capacity for normal use, the electric power supply system reflects the status and starts only the fuel cell system that is expected to be able to start in a short time. The electric power supply system starts another fuel cell system by using the electric power generated by the fuel cell system whose startup has been completed. In accordance with this feature, the electric power supply system can initiate the startup of the fuel cell system quickly while suppressing the electrical power consumption related to the startup of the fuel cell system.

### Supplementary Note 7

In the electric power supply system according to Supplementary Note 1, the control device may be configured to start the supply of the electric power to the load, in the case that the total value (Pall) of electric powers that are capable of being output by the fuel cell systems which have been started is equal to or greater than the value of the electric power required by the load.

In accordance with such a configuration, the electric power supply system can promptly start supply of electric power to the load without waiting for the startup completion of all the fuel cell systems. In accordance with this feature, the startup responsiveness of the electric power supply system can be improved.

### Supplementary Note 8

In the electric power supply system according to Supplementary Note 1, the control device may be configured to exclude any of the fuel cell systems in which a failure has occurred, from the target fuel cell systems for setting the priorities.

In accordance with such a configuration, the electric power supply system does not have to wait for the fuel cell system that cannot be started to complete the startup, and therefore, the electric power supply system can promptly start supply of electric power to the load.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of each of the operations and the order of each of the processes are shown as examples, and the present invention is not limited to such operations and processes. The same applies to the case where numerical values or mathematical expressions are used in the description of the above-described embodiments.

1. An electric power supply system equipped with a secondary battery configured to be connected to a load, and a plurality of fuel cell systems configured to be connected to the load and the secondary battery, the electric power supply system controlling startups of the plurality of fuel cell systems and supply of an electric power to the load, the electric power supply system comprising:
a remaining capacity acquisition device configured to acquire a remaining capacity of the secondary battery;
a temperature acquisition device configured to acquire a temperature of each of the fuel cell systems; and
one or more processors that execute computer-executable instructions stored in a memory,
wherein the one or more processors execute the computer-executable instructions to cause the electric power supply system to:
calculate a required startup power as an electric power required to start each of the fuel cell systems;
set priorities indicating order of startups on the plurality of fuel cell systems in accordance with the temperature and the required startup power of each of the fuel cell systems, and the remaining capacity of the secondary battery; and
start the plurality of fuel cell systems in accordance with the priorities.

2. The electric power supply system according to claim 1, wherein the one or more processors execute the computer-executable instructions to cause the electric power supply system to:
set a same priority on the plurality of fuel cell systems in a case that the remaining capacity of the secondary battery is equal to or greater than a predetermined value; and
start the plurality of fuel cell systems simultaneously.

3. The electric power supply system according to claim 1, wherein the one or more processors execute the computer-executable instructions to cause the electric power supply system to:
select, in a case that the remaining capacity of the secondary battery is less than a predetermined value, at least one fuel cell system having a highest temperature from among the fuel cell systems that have not been started; and
set a higher priority on the selected at least one fuel cell system than another fuel cell system; and
start the selected at least one fuel cell system with precedence over the other fuel cell system.

4. The electric power supply system according to claim 3, wherein the one or more processors execute the computer-executable instructions to cause the electric power supply system to:
in a case that at least two fuel cell systems are selected from among the fuel cell systems that have not been started,
set a same priority on the selected at least two fuel cell systems, on a condition that a total value of the required startup powers of the selected at least two fuel cell systems is less than the remaining capacity of the secondary battery, and
start the selected at least two fuel cell systems with precedence over another fuel cell system.

5. The electric power supply system according to claim 3, wherein the one or more processors execute the computer-executable instructions to cause the electric power supply system to:
after the startup of the at least one fuel cell system from among the plurality of the fuel cell systems has been completed,
set the priorities in accordance with the temperature and the required startup power of each of the fuel cell systems, the remaining capacity of the secondary battery, and an output electrical power of the at least one fuel cell system whose startup has been completed, and
start any of the fuel cell systems that have not been started by using at least one of the electric power supplied from the secondary battery or the output electric power of the at least one fuel cell system whose startup has been completed.

6. The electric power supply system according to claim 1, wherein the one or more processors execute the computer-executable instructions to cause the electric power supply system to:
select, in a case that the remaining capacity of the secondary battery is smaller than a predetermined value that indicates a lower limit of capacity for normal use of the secondary battery, a first fuel cell system having a highest temperature from among the plurality of fuel cell systems that have not been started;
set a higher priority on the selected first fuel cell system than other fuel cell systems;
start only the selected first fuel cell system by using the electric power supplied from the secondary battery;
select, after completing a startup of the first fuel cell system, a second fuel cell system having a second highest temperature from among the plurality of fuel cell systems that have not been started; and
start the second fuel cell system by using an output electric power of the first fuel cell system.

7. The electric power supply system according to claim 1, wherein the one or more processors execute the computer-executable instructions to cause the electric power supply system to start the supply of the electric power to the load, in a case that a total value of electric powers that are capable of being output by the fuel cell systems which have been started is equal to or greater than a value of an electric power required by the load.

8. The electric power supply system according to claim 1, wherein the one or more processors execute the computer-executable instructions to cause the electric power supply system to exclude any of the fuel cell systems in which a failure has occurred, from target fuel cell systems for setting the priorities.
